(19) United States
(12) Patent Application Publication
(10) Pub. No.: US 2007/0272732 A1
(43) Pub. Date: Nov. 29, 2007

(54) WEIGHING AND DIMENSIONING SYSTEM AND METHOD FOR WEIGHING AND DIMENSIONING

(75) Inventor: Hugh G. Hindmon, Powell, OH (US)

Correspondence Address: STANDLEY LAW GROUP LLP, 495 METRO PLACE SOUTH, SUITE 210, DUBLIN, OH, 43017, US

(73) Assignee: Mettler-Toledo, Inc., Columbus, OH (US)

(21) Appl. No.: 11/557,130

(22) Filed: Nov. 7, 2006

Related U.S. Application Data
(60) Provisional application No. 60/803,315, filed on May 26, 2006.

(51) Int. Cl. G06F 17/00; G06K 7/10

(52) U.S. Cl. 235/375; 235/462.13

(57) ABSTRACT

A system and method for weighing and dimensioning an object is described. The system may include a weighing apparatus and a dimensioner. The dimensioner may begin dimensioning the object after receiving a signal from the weighing apparatus. In one exemplary embodiment, a terminal may send the signal. The terminal may also receive and display the results received from the weighing apparatus and dimensioner.

This application claims the priority benefit of U.S. Provisional Patent Application No. 60/803,315, filed May 26, 2006, which is hereby incorporated by reference in its entirety.

### BACKGROUND AND SUMMARY OF THE INVENTION

The present invention relates generally to weighing and/or dimensioning systems and more specifically to a weighing and dimensioning system which may use a stable weight signal to initiate a dimensioner to determine the dimensions of an object to be weighed.

Weighing and dimensioning systems are generally known. As used herein, the term “dimensions” means length, width, height or any combination thereof, the term “dimensioner” means any system that may determine the dimensions of an object, the terms “dimensioning” and “dimensioned” mean measuring the dimensions of an object. Many systems may be known to determine the weight and/or dimensions of an object. One such system may be an in-motion system. In-motion systems may include a weighing apparatus, a dimensioner, a terminal and/or a bar code reader. An object to be weighed and dimensioned may arrive at the weighing apparatus from a downstream conveyor belt. The weighing apparatus may send weight signals to a terminal. The dimensioner may be upstream, downstream or at the same station as the weighing apparatus. A photo eye or light beam may be positioned at the front of each belt. Once an object breaks the photo eye or light beam the dimensioner may begin dimensioning the object. The reader may typically follow the dimensioner and may not be used to trigger the dimensioner.

In static dimensioning and/or weighing apparatus a button on the dimensioner or terminal may be manually pressed to signal the dimensioner to begin dimensioning the object. With either in-motion or static systems, the dimensioner may determine the dimensions of the object. Once the dimensions are determined the object may travel downstream or be removed from the weighing apparatus and the next object may arrive or be placed on the weighing apparatus. If weighing and dimensioning multiple packages such a system may be time-consuming and error prone.

Exemplary embodiments of the present invention may solve or mitigate the problems associated with known systems. A weighing and dimensioning system may include a weighing apparatus and a dimensioner. The dimensioner may be adapted to begin dimensioning an object upon receiving a stable weight signal from the weighing apparatus. The system may also include a terminal which may display the results received from the dimensioner.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates a perspective view of one exemplary embodiment of a weighing and dimensioning system of the present invention.

FIG. 2 illustrates a top plan view of an exemplary embodiment of a terminal of a weighing and dimensioning system of the present invention.

FIG. 3 illustrates a perspective view of an exemplary embodiment of a reader of a weighing and dimensioning system of the present invention.

FIG. 4 illustrates a perspective view of another exemplary embodiment of a weighing and dimensioning system of the present invention.

FIG. 5 illustrates a perspective view of another exemplary embodiment of a weighing and dimensioning system of the present invention.

FIG. 6 illustrates a perspective view of another exemplary embodiment of a weighing and dimensioning system of the present invention.

FIG. 7 illustrates a perspective view of another exemplary embodiment of a weighing and dimensioning system of the present invention.

FIG. 8 illustrates a flow diagram of an exemplary embodiment of a method of weighing and dimensioning of the present invention.

FIG. 9 illustrates a flow diagram of another exemplary embodiment of a method of weighing and dimensioning of the present invention.

### DETAILED DESCRIPTION OF THE EXEMPLARY EMBODIMENT(S)

Exemplary embodiments of the present invention may be directed to systems and methods for weighing and dimensioning various objects. Some exemplary embodiments of the present invention may be useful in weighing and dimensioning packages to be shipped. Nevertheless, it should be recognized that other objects may be weighed and dimensioned by exemplary embodiments of the present invention.

In an exemplary embodiment of the present invention, a dimensioner may be associated with a weighing apparatus. Any weighing apparatus may be used. For example, a scale from the PS family of scales, such as the PS60, available from Mettler-Toledo, Inc., of Columbus, Ohio may be used. Similarly, any dimensioner may be used, for example, the CNS810 available from Mettler-Toledo, Inc., of Columbus, Ohio. In an exemplary embodiment of the present invention, the system may be adapted to initiate dimensioning of an object with a dimensioner upon achieving a stabilized weight condition at a weighing apparatus. For example, when the weighing apparatus recognizes a stabilized weight condition, it may send a signal to the dimensioner to begin dimensioning the object. The weighing apparatus may determine when the weight is stable based on monitoring the fluctuations of the weight signals. Once the fluctuations are below a certain level a flag may be set. Filter settings may be set to adjust the level at which the flag may be set. The dimensioner may determine the dimensions and the weighing apparatus may determine the weight of the object. The weighing apparatus and terminal may be supported and positioned in anyway. For example, the weighing apparatus may be placed on the floor and the dimensioner mounted on a ceiling or wall. The weighing apparatus may also be mounted on a table or platform or mounted to a wall. The dimensioner and weighing apparatus may also be supported by a frame. A terminal may also be associated with the dimensioner and weighing apparatus. The terminal may receive and display the weight and dimensions from the weighing apparatus and dimensioner. The terminal may be any device known in the art capable of displaying the weight and dimensions. For example, the terminal may be a “dumb” terminal which is preprogrammed to display the weight and dimensions. The “dumb” terminal may include a plurality of buttons which are preprogrammed for a specific function such as activating the dimensioner. The terminal may also be a “smart” terminal, such as the JXOI (JAGXTREME® Operator Interface) available from Mettler-Toledo, Inc. of Columbus, Ohio or a personal computer and display.

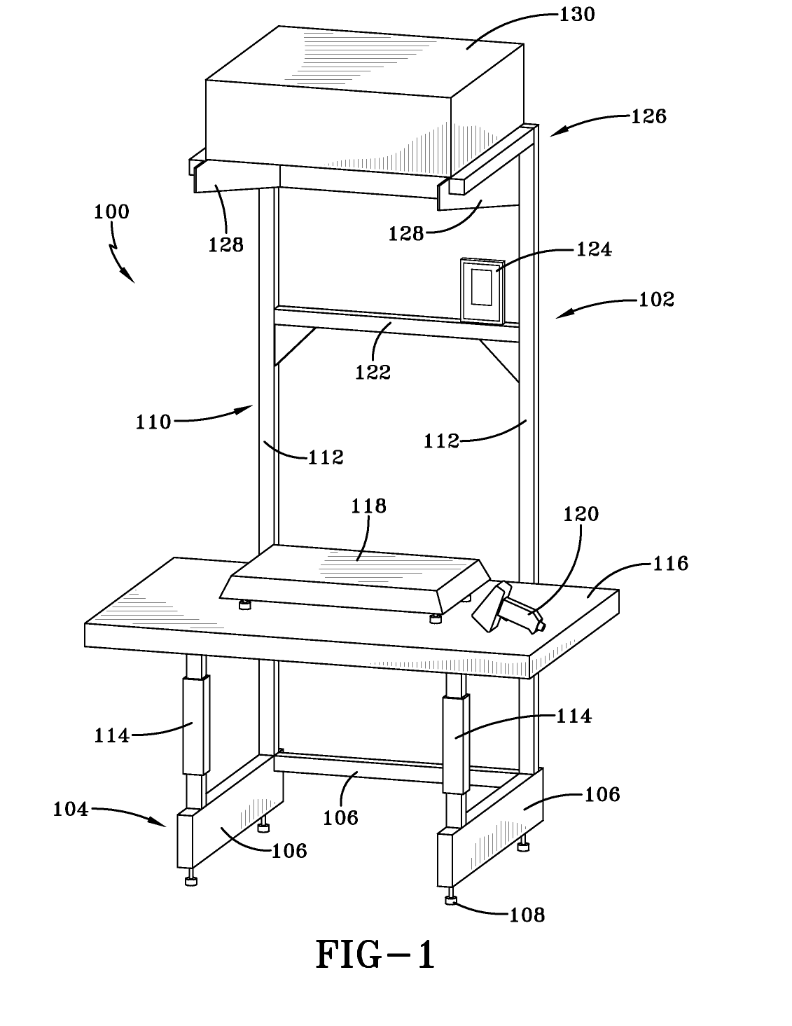

FIG. 1 illustrates an example of a weighing and dimensioning system 100. The system 100 may include a frame 102. The frame 102 may be a single integral piece or a plurality of pieces connected together by fasteners, welding or other similar joining methods. The frame 102 may be made of any material known in the art, so long as it is strong enough to support the structure and components which are attached thereto. For example, the frame 102 may be made of aluminum, steel or any other metals, plastic and/or wood. The frame 102 may have a lower support 104. The lower support 104 may have any configuration adapted to keep the system 100 upright. For example, the lower support 104 may include a plurality of lower support rails 106. In one exemplary embodiment, the lower support rails 106 are substantially horizontal and have a rectangular configuration. Any number of lower support rails 106 may be used. The lower support rails 106 may include a plurality of feet 108. Any number of feet 108 may be used. The feet 108 may be adjustable relative to the lower support rails 106 so that the system 100 may be level. The lower support 104 may be integral with or connected to a side support 110. The side support 110 may include a plurality of side support rails 112. The frame 102 may also include a plurality of legs 114 which may be adapted to support a platform 116. The legs 114 may be adjustable to allow the platform 116 to assume a plurality of different heights.

The platform 114 may support a weighing apparatus 118. The platform 114 may be made of any known materials including, but not limited to, metal, plastic and wood. The weighing apparatus may include at least one load cell. The weighing apparatus 118 may be any weighing apparatus known in the art. The system may also include a reader 120. The reader 120 may be adapted to read a 2D bar code, 3D dot matrix code, RFID tag or any other code adapted to uniquely identify an object. The weighing apparatus may be supported in a variety of ways. For example, the weighing apparatus may: be placed on a floor, be supported on a stand, be supported on a platform, be integrated into a platform, support a platform or support a plurality of rollers or belt.

The side support rails 112 may be connected by a cross support 122. The cross support 122 may give additional support to the frame 102. The system 100 may include a terminal 124. The terminal 124 may be supported anywhere on or near the frame 102 and/or platform 116. In one exemplary embodiment, the terminal 124 may be integrated into or integral with the weighing apparatus 118, reader 120 and/or a dimensioner 130. The frame 102 may include an upper support 126. The upper support 126 may have any configuration adapted to support the dimensioner 130. The dimensioner 130 may be any dimensioner known in the art. In one exemplary embodiment, the dimensioner 130 may be hung from a ceiling, mounted to a pole or against a wall. Similarly, the terminal 124 may be mounted on a pole or wall. In one exemplary embodiment, the dimensioner 130 may use a laser range finder with rotating mirrors to move the beam along the x-axis and a sweep mirror to fan the beam across the measurement field to determine the dimensions of the object. In another exemplary embodiment, the dimensioner 130 may use a camera, an ultrasonic range finder and/or any combination of these devices to determine the dimensions of an object. In another exemplary embodiment, the dimensioner 130 may detect whether or not an object is present on the weighing apparatus 118 before attempting to dimension the object. If an object is not detected, an error message may be displayed on the terminal 124. The dimensioner 130 may also determine whether or not the object is placed in a correct position. If the object is incorrectly positioned an error may be displayed. For example, this may be useful when a platform is used in addition to a weighing apparatus and the platform and weighing apparatus are of different heights. The dimensioner may be calibrated at setup to store the plane of the surface of the weighing apparatus based on its height. If an object is placed on a surface that is not equal to the height of the weighing apparatus then an incorrect measurement will occur. By detecting whether or not the object is in a correct position on the weighing apparatus, this can be avoided.

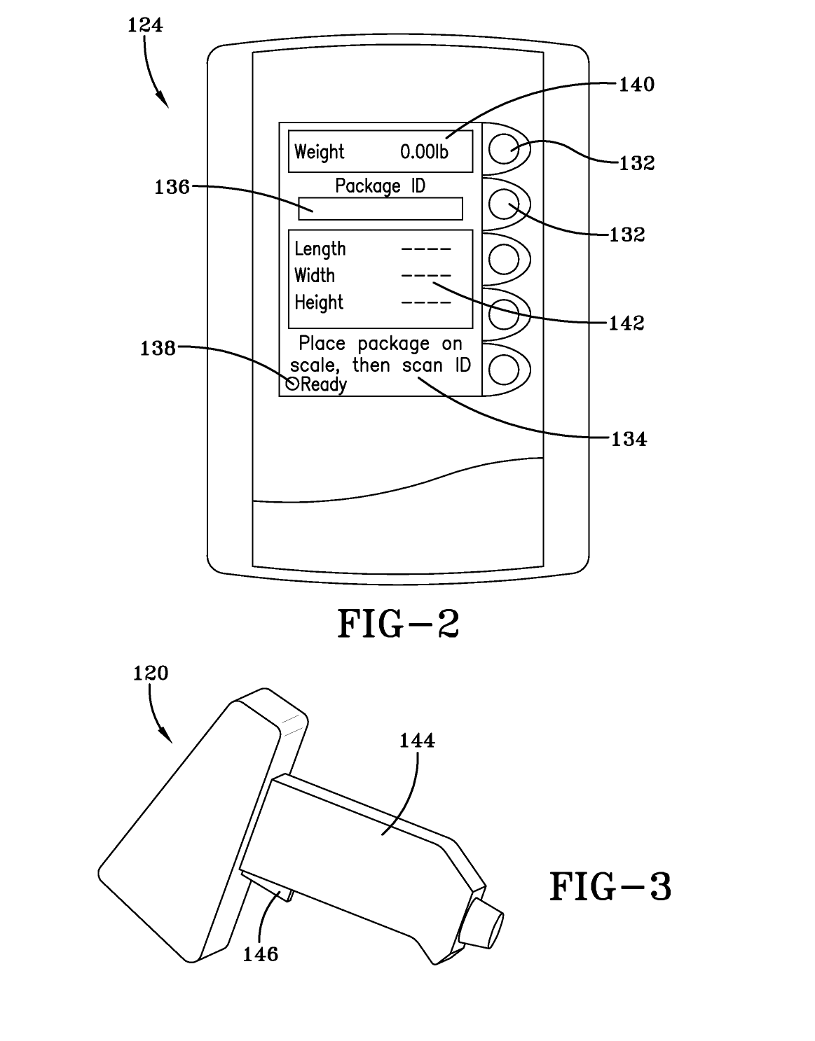

FIG. 2 illustrates an exemplary embodiment of a terminal of the present invention. A terminal 124 may be adapted to display the weight and dimensions of the object being weighed and dimensioned. In one exemplary embodiment, the terminal 124 may receive a stable weight signal from the weighing apparatus 118. After receiving the stable weight signal, the terminal 124 may send a signal to the dimensioner 130 to initiate a scan of an object. The terminal 124 may also perform a variety of calculations, including but not limited to, conversions, the density, volume, and/or DimWeight of the object. The terminal 124 may include a plurality of buttons 132 for navigating through a series of menus. The terminal 124 may have a display 134 displaying the weight and dimensions, as well as, any number of menus, error messages or any other similar screens. In one exemplary embodiment, the display 134 may be divided into a plurality of portions. Any number of portions having any function may be used. For example, the display 134 may include a package ID indicator portion 136, a status indicator portion 138, a weight indicator portion 140 and a length, width and height indicator portion 142. The terminal 124 may be a standalone unit or may be integrated into or an integral part of the weighing apparatus 118, dimensioner 130 and/or reader 120. The terminal 124, weighing apparatus 118, dimensioner 130 and/or reader 120 may be connected to one another through any connections known in the art. For example, the terminal 124, weighing apparatus 118, dimensioner 130 and/or reader 120 may be connected by serial cables, Ethernet cables, wireless connections and/or any other connection known in the art. The terminal 124, weighing apparatus 118, dimensioner 130 and/or reader 120 may also be connected to a computer network and may transmit information to or from a computer or computers also connected to the network. The network may be any network known in the art, such as, but not limited to, a LAN, a WAN and/or the Internet.

FIG. 3 illustrates an exemplary embodiment of a reader of the present invention. A reader 118 may include a handle 144 and trigger 146. The reader 118 may emit a pattern of light which may scan a code and transmit a signal to the terminal 124. The pattern of light may be any pattern known in the art such as a laser line, square or any other similar pattern. The reader 118 may also be an RFID reader which may detect a radio frequency signal or code emitted by an RFID tag. The reader 118 may also be a CCD scanner which may scan an image of the code and extract data from the image. The code may be any computer readable code known in the art such as a 2D bar code, a 3D dot matrix code, RFID tag, a package identifier or any other similar code. The signal transmitted by the reader 118 to the terminal 124 may contain an identifier for the object to be weighed and dimensioned. For example, the signal may be a package ID, order number, tracking number, etc.

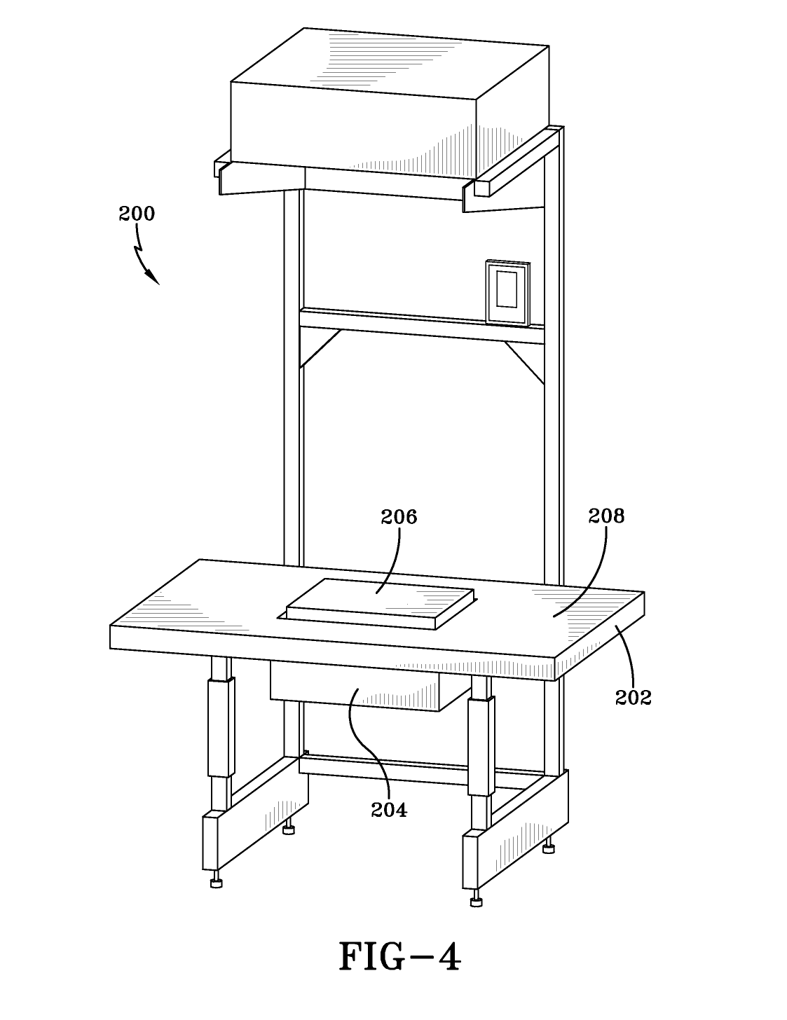

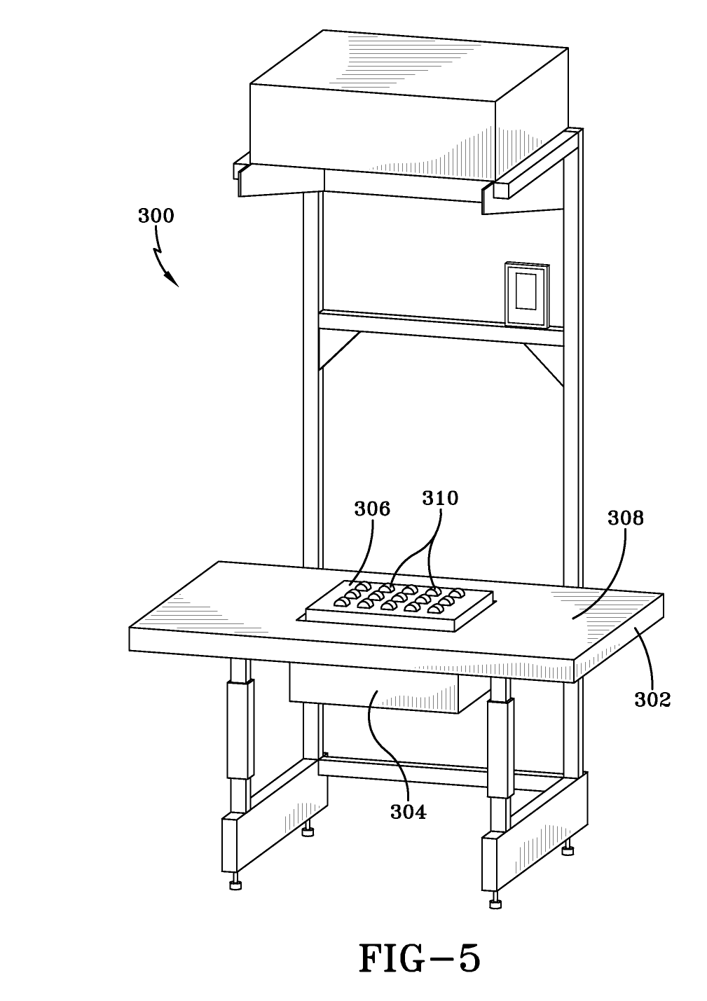

FIGS. 4-7 illustrate other exemplary embodiments of a system of the present invention. In FIG. 4, the system 200 may be generally similar to FIG. 1. The system 200 may include a platform 202 which may contain a recess 204. The recess 204 may receive a weighing apparatus 206. The recess 204 may be any size which may be large enough to receive the weighing apparatus 206. For example, the recess 204 may be sized large enough to receive most of the weighing apparatus 206 while allowing a portion of the weighing apparatus 206 to protrude above the upper surface 208 of platform 202. In one exemplary embodiment, the recess 204 may be adjustable to adjust the height of the recess 204 relative to the upper surface of the platform 208. FIG. 5 shows another exemplary embodiment similar to that shown in FIG. 4. In FIG. 5, the system 300 may include a platform 302, which may include a recess 304, which may receive a weighing apparatus 306. Similarly, the weighing apparatus 306 may protrude above the upper surface 308 of the platform 302. The weighing apparatus 306 may include a plurality of rollers 310. The rollers 310 may assist in handling an object, including objects of large size or weight.

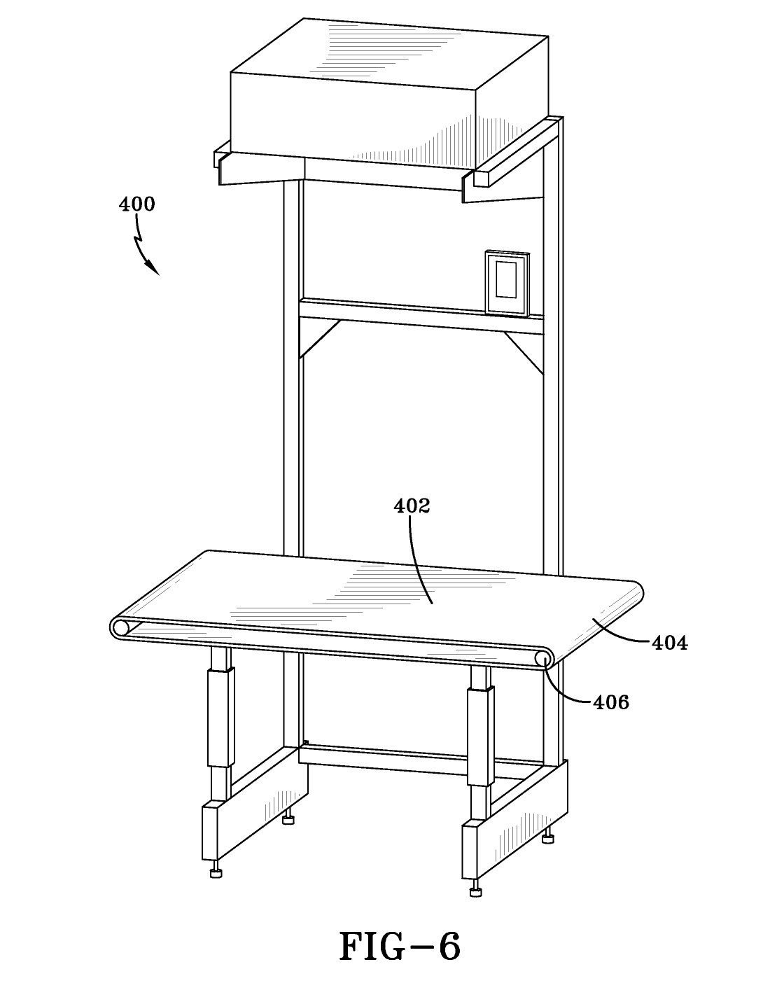

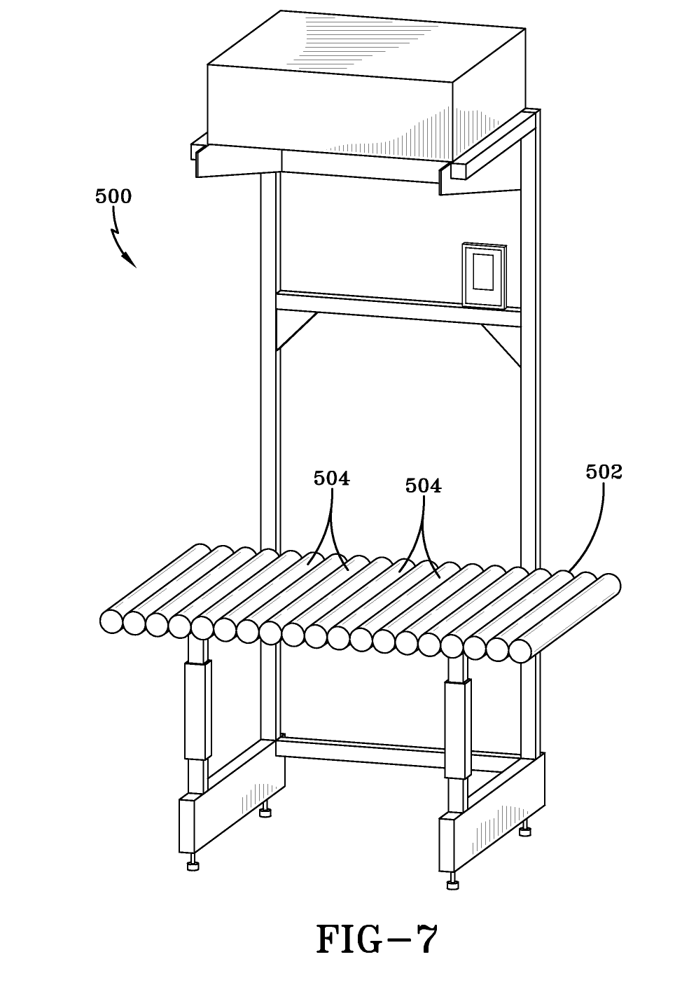

FIG. 6 illustrates another exemplary embodiment of a system of the present invention. The system 400 may include a weighing apparatus 402. The weighing apparatus 402 may include a belt 404 and at least one drive roller 406. The drive roller 406 may be driven by a motor which may cause the belt to rotate about the at least one drive roller 406. In an exemplary embodiment, the system 400 may be disposed between an upstream conveyor belt system and a downstream conveyor belt system. Objects may arrive from an upstream conveyor belt system, may be weighed and dimensioned at the system 400 and then continue on the downstream conveyor belt system. FIG. 7 illustrates another exemplary embodiment of a system of the present invention which may be similar to the exemplary embodiment of FIG. 6. In FIG. 7, the system 500 may include a weighing apparatus 502 which may include a plurality of rollers 504.

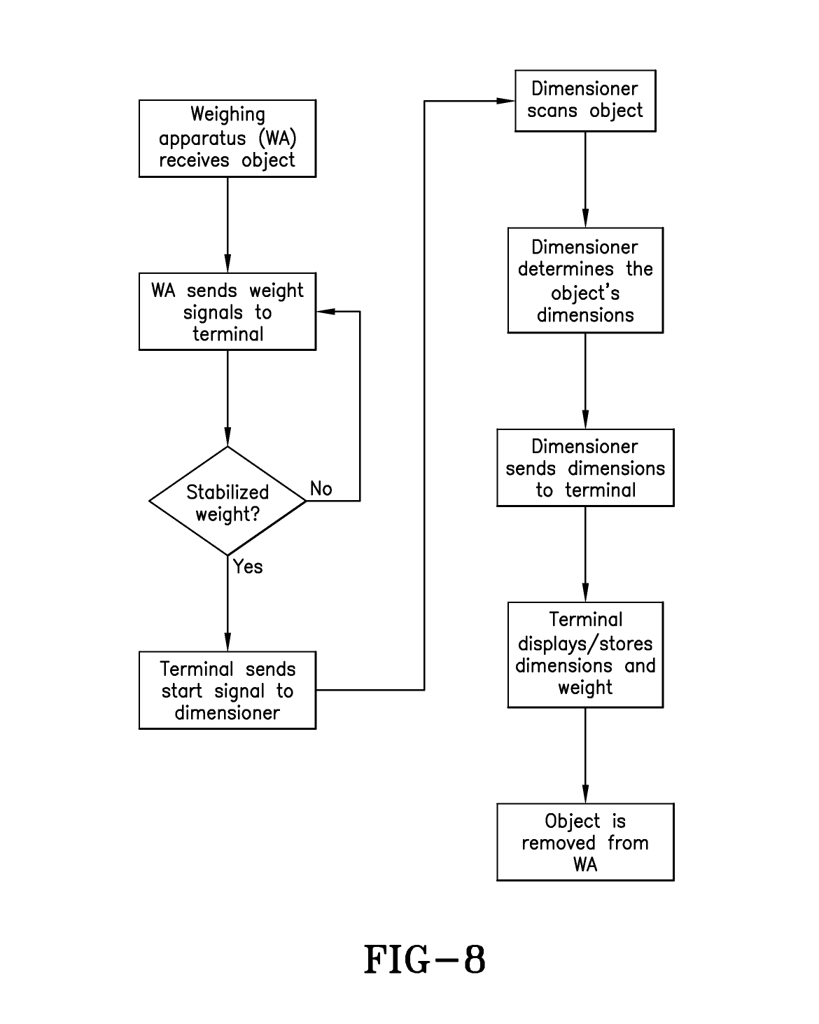

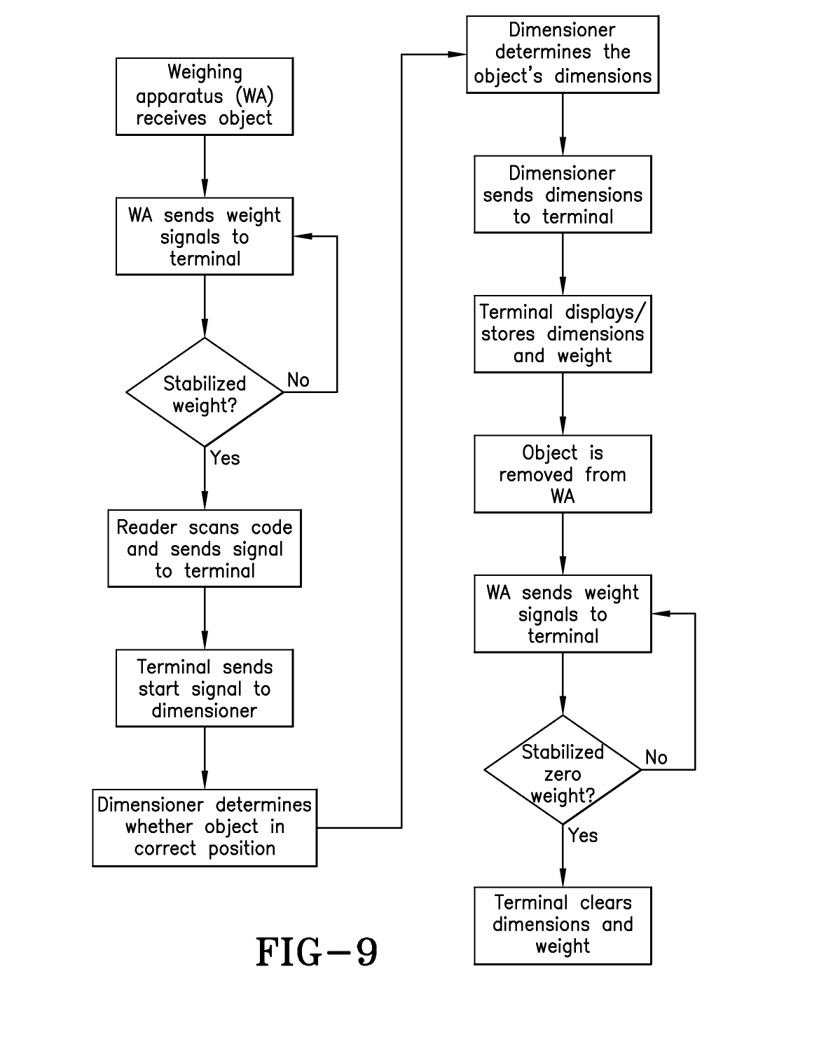

FIGS. 8 and 9 illustrate exemplary embodiments of methods of weighing and dimensioning of a system of the present invention. A weighing apparatus may receive an object to be weighed and dimensioned. The weighing apparatus may send weight signals to a terminal. Next, the weighing apparatus may send a stable weight indicator to the terminal or set a flag, indicating that a stable weight above zero has been obtained. The terminal may display any number of indicators to show that there is still instability at the weighing apparatus including, but not limited to, a tilde (~) symbol, zero weight, or an enunciator. Alternatively, the terminal may monitor the weight signals to determine when a stabilized weight signal has been obtained. Once a stable weight indicator or stabilized weight signal is detected, the terminal may send a start signal to a dimensioner. Next, the dimensioner may scan the object and may then determine the dimensions of the object. Optionally, a time delay may be included to give an operator time to move away from the object to be scanned. In one exemplary embodiment, if the object is too large or not properly positioned an error signal may be sent to the terminal and an error message displayed. Adjustments to the position of the object may be made and a button may be pressed on the terminal to rescan the object. Irregular objects in the view of the dimensioner, such as, hands of an operator may also generate an error. Optionally, before dimensioning the object, the dimensioner may determine whether or not an object is present. If an object is not present, an error signal may be sent to the terminal and an error message displayed. Next, the dimensioner may send the dimensions to the terminal, where the dimensions and weight may be displayed on a display and/or stored in memory. Finally, the object may be removed from the weighing apparatus and the steps may be repeated for the next object. In one exemplary embodiment, the terminal may continue to receive weight signals after the object has been removed from the weighing apparatus. The weighing apparatus may set a flag when a stable zero weight occurs. This is similar to the method described above for stable weight above zero. A center of zero flag may also be set. Once either flag is set, the terminal may clear the weight and dimensions from the display. At anytime, an object may be re-scanned by pressing an appropriate button on the terminal. At any step in the process a reader may scan a code and send a signal to the terminal with information about the object to be scanned. During any step a prompt may be displayed at the terminal. For example, when the system is idle, a message may indicate, “Place a package on the scale” or when the dimensioner is dimensioning the object, a message may indicate, “Please wait for dimensions.”

While certain exemplary embodiments of the present invention are described in detail above, the scope of the invention is not to be considered limited by such disclosure, and modifications are possible without departing from the spirit of the invention as evidenced by the following claims:

What is claimed is:

1. A weighing and dimensioning system comprising:
a weighing apparatus adapted to receive an object; and
a dimensioner associated with said weighing apparatus;
wherein said dimensioner is adapted to begin dimensioning said object upon indication of a stable weight condition of said weighing apparatus.

2. The weighing and dimensioning system of claim 1 wherein said weighing apparatus sends a stable weight signal to said dimensioner to initiate dimensioning said object.

3. The weighing and dimensioning system of claim 1 further comprising:
a terminal electronically connected to said weighing apparatus and said dimensioner;
wherein said terminal is adapted to receive a stable weight signal from said weighing apparatus and to send a signal to said dimensioner to initiate dimensioning said object.

4. The weighing and dimensioning system of claim 3 said terminal further comprising:
a display adapted to display at least one dimension of said object and a weight of said object.

5. The weighing and dimensioning system of claim 4 further comprising:
a reader associated with said terminal for scanning a code for identifying said object.

6. The weighing and dimensioning system of claim 1 further comprising:
a terminal electronically connected to said weighing apparatus and said dimensioner;
wherein said terminal is adapted to detect a stable weight condition of said weighing apparatus and to send a signal to said dimensioner to initiate dimensioning said object.

7. The weighing and dimensioning system of claim 1 wherein said terminal is adapted to perform a calculation selected from the group consisting of, a conversion, the density of said object, the volume of said object and the DimWeight of said object

8. A weighing and dimensioning system comprising:
a weighing apparatus adapted to receive an object; and
a dimensioner associated with said weighing apparatus;
wherein said dimensioner is adapted to determine if said object is in a correct position on said weighing apparatus for dimensioning said object.

9. The weighing and dimensioning system of claim 8 wherein said dimensioner is adapted to begin dimensioning said object upon indication of a stable weight condition of said weighing apparatus.

10. The weighing and dimensioning system of claim 8 further comprising:
a terminal electronically connected to said weighing apparatus and said dimensioner;
wherein said terminal is adapted to receive a stable weight signal from said weighing apparatus and to send a signal to said dimensioner to initiate dimensioning said object.

11. The weighing and dimensioning system of claim 10 said terminal further comprising:
a display adapted to display at least one dimension of said object and a weight of said object.

12. The weighing and dimensioning system of claim 11 further comprising:
a reader associated with said terminal for scanning a code for identifying said object.

13. The weighing and dimensioning system of claim 8 further comprising:
a terminal electronically connected to said weighing apparatus and said dimensioner;
wherein said terminal is adapted to detect a stable weight condition of said weighing apparatus and to send a signal to said dimensioner to initiate dimensioning said object.

14. The weighing and dimensioning system of claim 13 wherein said terminal is adapted to perform a calculation selected from the group consisting of, a conversion, the density of said object, the volume of said object and the DimWeight of said object.

15. A method of weighing and dimensioning an object, comprising:
placing said object on a weighing apparatus;
detecting the weight of said object;
indicating a stable weight condition; and
dimensioning the dimensions of said object upon indication of said stable weight condition.

16. The method of weighing and dimensioning of claim 15, further comprising:
displaying the weight of said object at a terminal.

17. The method of weighing and dimensioning of claim 15, further comprising:
displaying the dimensions and weight of said object at a terminal.

18. The method of weighing and dimensioning of claim 17, further comprising:
removing said object from said weighing apparatus;
indicating a stable zero weight condition; and
clearing said dimensions and said weight from said terminal.

19. The method of weighing and dimensioning of claim 15, further comprising:
determining whether the object is in a correct location.

20. The method of weighing and dimensioning of claim 19, further comprising:
displaying an error message at a terminal if said object is not in a correct location.
